(19) United States
(12) Patent Application Publication
(10) Pub. No.: US 2006/0180282 A1
(43) Pub. Date: Aug. 17, 2006

(54) Building door consisting of serveral mutually articulated panels

(76) Inventor: Claude Andre Pierre Requet, Chaucenne (FR)

Correspondence Address: CASELLA & HESPOS, 274 MADISON AVENUE, NEW YORK, NY, 10016, US

(21) Appl. No.: 10/535,586

(22) PCT Filed: Nov. 18, 2003
(86) PCT No.: PCT/IB03/05218

§ 371 Date: Jun. 29, 2005

(30) Foreign Application Priority Data
Nov. 19, 2002 (FR) 02/14457

(51) Int. Cl. E06B 9/00

(52) U.S. Cl. 160/201; 160/229.1

(57) ABSTRACT

The invention concerns a building door consisting of several panels (5) guided along a curvilinear guide rail such that said panels remain more or less parallel to the rail and mutually articulated about hinge pins (10) parallel to their longitudinal edges through pivoting elements (9). The invention is characterized in that the panels (5) are provided at their longitudinal edges with male and female anti-finger catching complementary profiles, and in that the hinge pins (10) of the pivoting elements (9) are at least more or less coplanar to the inner walls (6) of the panels (5) whereto they are articulated and in that the pivoting elements (9) are linked to the transverse edges of the panels (5). Said door is simple, aesthetic and its structure enables prevention of accidents caused by pinching, in particular finger catching.

The invention relates to a building door, that can move, made up of several panels guided along at least one curvilinear guide rail in such a way that these panels remain at least approximately parallel to the rail and articulated to one another about axes of pivoting parallel to their longitudinal edges by virtue of pivot elements.

Building doors which can move, and are made up of several panels guided along at least one curvilinear guide rail and articulated to one another about axes of pivoting by virtue of pivot elements are known. These doors may exhibit panels the length of which is equal to the height of the opening that is to be closed off, and may be able to move horizontally, or may exhibit panels the length of which is equal to the width of the opening that is to be closed off, and may be able to move vertically.

The door is made up of various panels so that it can follow as closely as possible the direction of movement defined by the rails and so that the clearance space needed for opening the door can be reduced as far as possible.

Such doors exhibit disadvantages.

First of all, as the panels are able to rotate relative to one another as the door moves, it is necessary to leave a gap between two adjacent panels. The result of this is that draughts can pass through the door even when the door is closed. This problem has been solved in the field of elevator cars through the use of elastomer seals running the length of the panels where they are articulated together, as described in patent application EP 1 201 858. This solution is expensive. Again, in order to solve this problem, panels have been produced that have facing edge profiles that complement one another in order to form a baffle-type seal, as disclosed in document EP 1 002 931.

Next, an interior wall visible from inside the building and an exterior wall visible from outside the building are defined for the panels. These two walls, made of sheet or synthetic material, are separated from one another by a volume filled with a thermal and acoustic insulator. This structure of the panels means that two adjacent panels move closer together or further apart, at their interior walls and/or their exterior walls, when the door is moved and when these panels lie at points where the curvature of the rails change. These relative movements of the panels with respect to one another are particularly dangerous to fingers and may cause trapped fingers when the door is being driven by a user or by a mechanism. This is, for example, the case in documents EP 1 201 858, CH 343 624 and EP 1 002 931 or in document DE 15 09 261 describing a concertina-folding door. Special edge profiles for the panels, such as those described in patent U.S. Pat. No. 4,718,472 afford a partial solution to this problem by making it possible to avoid these risks of trapping at the outer walls of the panels.

Finally, the pivot elements that articulate the panels to one another consist of hinges fixed to the interior walls of the panels and distributed uniformly over their length. This solution is not very esthetically attractive and means that the axes of mutual articulation of the panels have to be sited on the outside of the thickness of the door unless grooves are milled in the panels for installing the hinges. This complicates the use of profiles such as those described in patent U.S. Pat. No. 4,718,472 where the axis of articulation between two adjacent panels lies more or less in the middle of the thickness of the door.

Patent U.S. Pat. No. 5,824,504 discloses a sectional door that allows some of these problems to be solved. Complementary elements are connected to the edges of the adjacent panels to avoid the risk of trapping and provide a seal. This solution is expensive and requires elements that extend over the entire length of the panels.

The object of the invention is to produce a building door that improves the doors of the prior art and alleviates the problems mentioned. In particular, the invention proposes to produce a door that is simple, esthetically attractive and the structure of which makes it possible to avoid the risks of accidents due to trapping, particularly the trapping of fingers.

The door according to the invention is characterized in that the panels are equipped at their longitudinal edges with complementary male and female anti-trapping profiles, in that the axes of pivoting of the pivot elements are at least approximately coplanar with the interior walls of the panels which they articulate, and in that the pivot elements are connected to the transverse edges of the panels.

The dependent claims 2 to 4 define alternative forms of embodiment of this door.

The attached drawing depicts, by way of example, one embodiment of the door according to the invention.

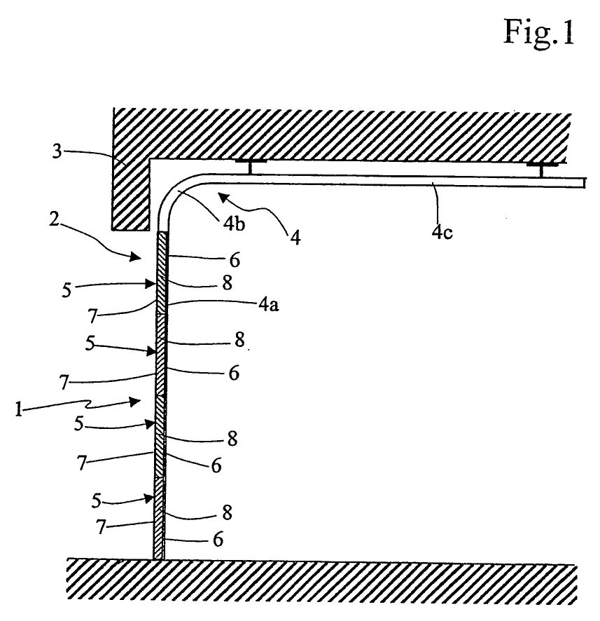

FIG. 1 is a view in section of a door according to the invention.

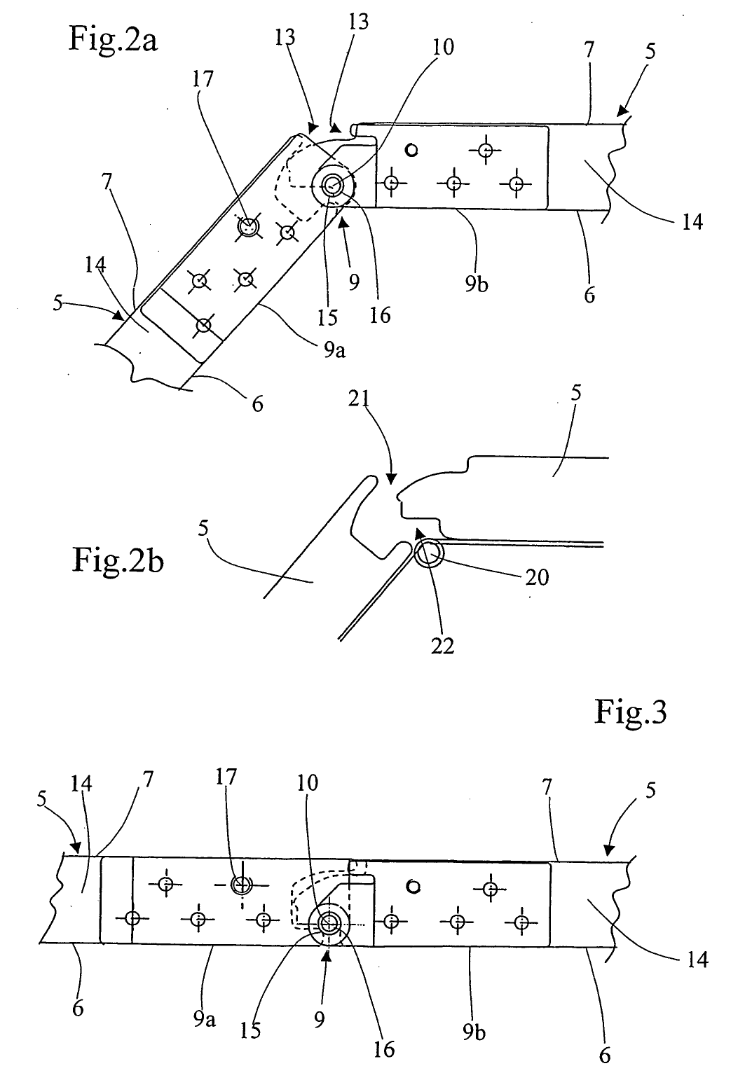

FIG. 2a is a detailed side view of this door at a pivot element connecting two adjacent panels when these panels are in a curved region of the guide rail.

FIG. 2b is a detailed side view of a door according to the prior art at a pivot element connecting two adjacent panels when these are in a curved region of the guide rail.

FIG. 3 is a view similar to that of FIG. 2a when the panels are in a rectilinear region of the guide rail.

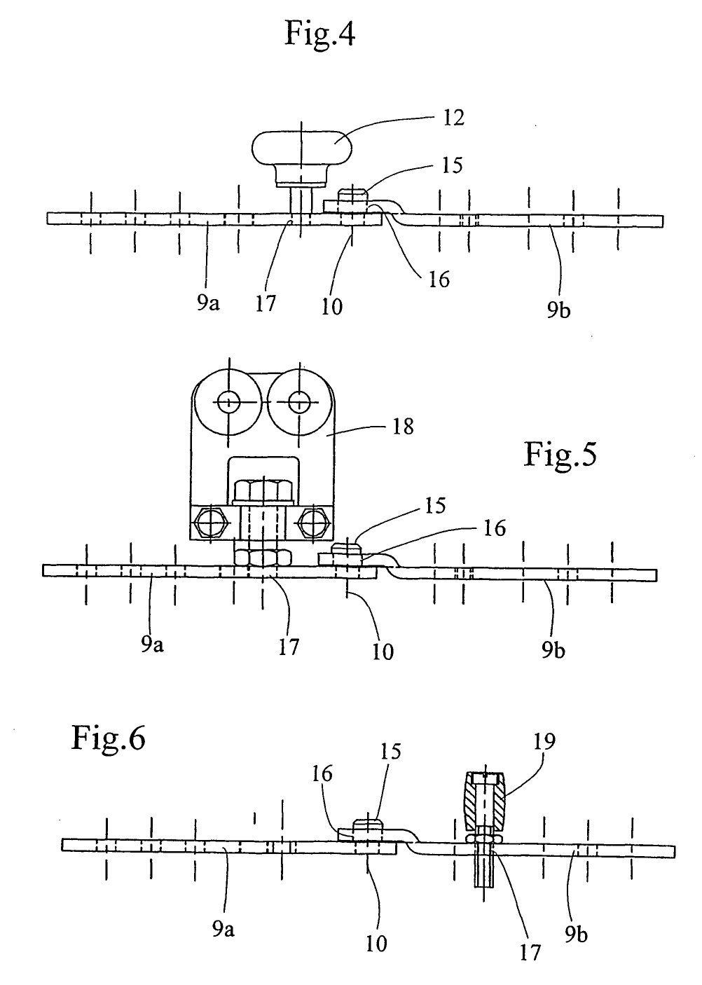

FIG. 4 is a side view of a pivot element for a vertically-moving door equipped with a guide roller.

FIG. 5 is a side view of an upper pivot element for a horizontally-moving door equipped with a guide carriage.

FIG. 6 is a side view of a lower pivot element for a horizontally-moving door equipped with a guide roller.

The door 1 depicted in FIG. 1 allows an opening 2 made in a building 3 such as a garage opening to be closed off. This door 1 retracts vertically to allow passage through the opening 2. To do this, on each side of the opening, two symmetric rails 4 are fixed to the inside of the building 3 to its structure. These two rails 4 have a curvilinear shape, made up of a vertical rectilinear part 4a connected by a blend radius 4b to a horizontal rectilinear part 4c diverging from the opening 2 toward the inside of the building. Thus, once open, the door 1 is horizontal under the roof of the building. These rails are made, for example, of steel C-section.

The door is made up of four panels 5 having a length roughly equal to the width of the opening 2. The walls 6, 7 of these panels, respectively defining the interior and exterior faces of the door 1, are made of steel sheet or synthetic material. The space between the interior 6 and exterior 7 walls is filled with a thermal and acoustic insulator 8 such as a polyurethane foam. The edges parallel to the direction of the rails 4 consist of a U-section 14 the two parallel flanges of which are connected to the interior 6 and exterior 7 walls of each panel. The adjacent panels 5 are joined together by pivot elements 9 depicted in FIGS. 2 and 3 and which allow them to rotate relative to one another about axes of pivoting 10 parallel to the length of the panels 5. At each articulation between two panels 5 and at the two, top and bottom, ends of the door 1 there are, on each side of the door 1, connected to this door, rollers 12 with horizontal axes running in the rails 4. The diameter of these rollers is equal, less the operating clearance, to the distance separating the upper flanges of the rails 4 from their lower flanges.

The facing longitudinal edges 13 of two adjacent panels 5 have complementary male and female shapes that nest together when the panels 5 move from a rail region 4b of high curvature to a region 4a, 4c of gentler curvature. These complementing shapes create a seal by acting as baffles to draughts.

The pivot elements 9 are made of sheet. They are made up of a part 9a known as the male part exhibiting a shaft 15, for example welded, the axis of which defines the axis of pivoting 10, and of a part 9b known as the female part exhibiting a drilling 16 that takes the shaft 15. These two parts 9a and 9b are attached respectively to two adjacent panels 5. These connections are made by screws passing through the parts 9a and 9b and screwing into tappings made in the U-sections 14 that define the transverse edges of the panels 5. One of the two parts 9a or 9b advantageously has at least one tapped hole allowing the attachment, as depicted in FIG. 4, of a roller 12 that guides the door 1 in the rails 4.

Such a structure of pivot element 9 makes it possible to site the axes of pivoting 10 where desired with respect to the thickness of the door panels 5, but also where desired with respect to the join between two consecutive panels. Thus, in the case of panels 5 exhibiting longitudinal edge profiles defined in FIG. 2a, this structure of pivot element allows the axes of pivoting to be located in the planes of the interior walls and thus allows any risk of trapping on the exterior face and on the interior face of the door to be avoided. If it is anticipated that the panels 5 will be connected by hinges 20 as known in the prior art and depicted in FIG. 2b, it may be pointed out that, when two adjacent panels are not aligned, dangerous gaps 21 and 22 appear on the interior and exterior faces of the door 1. In addition, the fact of positioning the axes of pivoting in the planes of the interior walls of the panels or in the thickness of the door makes it possible, when use is made of panels 5 exhibiting edge profiles defined in FIG. 2a, to use rails exhibiting a smaller blend radius and, therefore, to reduce the clearance space needed for opening the door. The profiles of the longitudinal edges of the panels and the location of the axes of pivoting of the panels at the planes of the interior walls of the panels contribute to providing an “anti-trap” safety function.

As the pivot elements exhibit parts attached to the edges of the panels, it is very practical, unlike in the devices known from the prior art, to fix the door guide rollers in the thickness of the panels. This allows the rails to be aligned with the transverse edges of the door and makes it possible to produce a more compact and esthetically attractive installation. Specifically, for safety and esthetic reasons, the rails, in their rectilinear parts, are located on each side of the door within the thickness thereof. The door and the rails are therefore visible in the same plane and, as depicted in FIG. 1, the rails, and therefore the guide elements that provide the interface between the panels and the rails protrude neither toward the front nor toward the rear of the door. This feature also makes it possible to afford a safety function. Specifically, as the space between the doors and the rails is relatively small, it is more difficult for foreign bodies to enter this space and the risks of injury or damage to the door are lower.

The pivot elements thus have two functions: on the one hand, that of embodying the axis of mutual pivoting of the panels and, on the other hand, that of supporting the guide rollers. They therefore allow the structure of the door to be simplified.

With pivot elements 9 according to the invention, there is no longer a need to distribute hinges over the entire length of the panels, and there is thus a certain saving in terms of the number of pivot elements to be mounted, and the esthetic appearance of the interior face of the door is improved.

In an alternative form of embodiment of the pivot elements 9, the parts 9a and 9b are produced by the U-sections 14. The ends of the sections have shapes that allow these sections to be articulated to one another.

The pivot elements described may be applied to a horizontally-moving garage door. To allow this movement, at the top of the opening and at ground level, two symmetric horizontal rails are fixed to the interior of the building to its structure. These two rails have a curvilinear shape made up of a horizontal rectilinear part connected by a blend radius to a horizontal rectilinear part diverging from the opening toward the inside of the building. Thus, once open, the door is perpendicular to the opening, for example against a wall of the building.

In this example, as in the previous one, each panel of the door is equipped with guide elements. Thus, at the top of the panels, the pivot elements depicted in FIG. 5 are equipped with articulated carriages 18 exhibiting two rollers running in the upper rail. At the bottom of the panels, the pivot elements depicted in FIG. 6 are equipped with rollers 19 of vertical axes running in the lower rail or with other guide elements sliding in an inverted or non-inverted U-shaped rail.

1. A building door (1), that can move, made up of several panels (5) guided along at least one curvilinear guide rail (4) in such a way that these panels remain at least approximately parallel to the rail and articulated to one another about axes of pivoting (10) parallel to their longitudinal edges by virtue of pivot elements (9), the panels (5) being equipped at their longitudinal edges with complementary male and female anti-trapping profiles, characterized in that the axes (10) of pivoting of the pivot elements (9) are at least approximately coplanar with the interior walls (6) of the panels (5) which they articulate, and in that the pivot elements (9) are connected to the transverse edges (14) of the panels (5).

2-5. (canceled)

6. The door (1) as claimed in claim 1, characterized in that the pivot elements (9) of the transverse edges (14) comprise a male (9a) part and female (9b) part which form a single piece.

7. The door (1) as claimed in claim 6, characterized in that the pivot elements (9) consist in shapings at the ends of the transverse edges (14) allowing the various panels (5) to be articulated.

8. The door (1) as claimed in claim 7, characterized in that the transverse edges (14) of the panels (5) comprise a male part (9a) at a first end and a female part (9b) at a second end to allow the various panels (5) to be articulated.

9. The door (1) as claimed in claim 8, characterized in that the male part (9a) has a shaft (15) the axis of which defines the axis of pivoting (10) and in that the female part (9b) has a drilling (16) to take a shaft (15).

10. The door (1) as claimed in claim 1, characterized in that the transverse edge of the panels consist of a U-section (14).

11. The door (1) as claimed in claim 10, characterized in that the U-section (14) has two parallel flanges connected to the interior (6) and exterior (7) walls of a panel (5).

12. The door (1) as claimed in claim 1, characterized in that the pivot elements (9) support the guide devices (12, 18, 19) within the thickness of the panels (5).

13. The door (1) as claimed in claim 12, characterized in that guide devices (12, 18, 19) intended to collaborate with the curvilinear guide rail or rails (4) are in a pivot connection with the pivot elements (9) in such a way that, in the rectilinear portions of the rails, the rails (5) are at least approximately located within the thickness of the panels.
